(19) United States
(12) Patent Application Publication
(10) Pub. No.: US 2013/0096976 A1
(43) Pub. Date: Apr. 18, 2013

(54) COST-EFFECTIVE AND RELIABLE UTILITIES DISTRIBUTION NETWORK

(71) Applicants: Charles Jay Alpert, Austin, TX (US); Peter Feldmann, New York, NY (US); Zhuo Li, Cedar Park, TX (US); Ying Liu, Austin, TX (US); Sani Richard Nassif, Austin, TX (US)

(72) Inventors: Charles Jay Alpert, Austin, TX (US); Peter Feldmann, New York, NY (US); Zhuo Li, Cedar Park, TX (US); Ying Liu, Austin, TX (US); Sani Richard Nassif, Austin, TX (US)

(73) Assignee: International Business Machines Corporation, Armonk, NY (US)

(21) Appl. No.: 13/275,609

(22) Filed: Oct. 18, 2011

(51) Int. Cl. G06Q 10/06

(52) U.S. Cl. 705/7.23

(57) ABSTRACT

A method, system, and computer program product for designing a cost-effective and reliable distribution network for a utility are provided in the illustrative embodiments. A graph connecting a set of consumers of the utility with a set of suppliers of the utility is reduced to form a plurality of clusters. A first network between a supplier and a subset of consumers in a first cluster in the plurality of clusters is improved, the improving adding a first connection in the first network to provide continuity of supply of the utility to the subset of consumers after a predetermined number of failures in the first network. A design is generated for a second network connecting the set of suppliers to the set of consumers, the second network including the first network after the improving, wherein the second network has a cost that is within a lower threshold and an upper threshold.

### BACKGROUND

1. Technical Field

The present invention relates generally to a method, system, and computer program product for creating or modifying a utilities distribution network. More particularly, the present invention relates to a method, system, and computer program product for creating or modifying a utilities distribution network such that the network is cost-effective and reliable.

2. Description of the Related Art

Utilities, such as electricity, water, and gas are supplied from several suppliers to several consumers. Utilities distribution occurs through a network of suitable conveyors of those utilities. For example, electricity is distributed through a network of electrical cables and grids; and water and gas are distributed over a network of pipelines.

New utilities distribution networks (networks) are designed when, for example, a new city or sub-division is being planned. Existing networks are modified as the distribution needs change, for example, when a new supplier comes on line, an old supplier ceases operation, or when consumers or demand patterns change.

A utilities distribution network is an expensive infrastructure. Building one requires significant capital investment. Maintenance of a network requires significant time and expense. Modifying an existing network is complex—involving cost, time, and downtime for the utilities services.

A utilities distribution network has to be reliable. For example, it is desirable that a fault in the network not disrupt the supply of the utility.

### SUMMARY

The illustrative embodiments provide a method, system, and computer program product for cost-effective and reliable utilities distribution network (network). An embodiment reduces a graph connecting a set of consumers of the utility with a set of suppliers of the utility to form a plurality of clusters. The embodiment improves a first network between a supplier and a subset of consumers in a first cluster in the plurality of clusters, the improving adding a first connection in the first network to provide continuity of supply of the utility to the subset of consumers after a predetermined number of failures in the first network. The embodiment generates a design for a second network connecting the set of suppliers to the set of consumers, the second network including the first network after the improving, wherein the second network has a cost that is within a lower threshold and an upper threshold.

### BRIEF DESCRIPTION OF THE SEVERAL VIEWS OF THE DRAWINGS

The novel features believed characteristic of the invention are set forth in the appended claims. The invention itself, however, as well as a preferred mode of use further objectives and advantages thereof, will best be understood by reference to the following detailed description of an illustrative embodiment when read in conjunction with the accompanying drawings, wherein:

FIG. 1 depicts a pictorial representation of an example electricity distribution network in which illustrative embodiments may be implemented;

FIG. 2 depicts a block diagram of a data processing system in which illustrative embodiments may be implemented;

FIG. 3 depicts a graph reduction process for designing a cost-effective network in accordance with an illustrative embodiment;

FIG. 4A depicts a simplified loop graph for reliability in accordance with an illustrative embodiment;

FIG. 4B depicts a second form of improving reliability in a utilities distribution network in accordance with an illustrative embodiment;

FIG. 5 depicts a flowchart of a process of designing a cost-effective and reliable utilities distribution network in accordance with an illustrative embodiment; and

FIG. 6 depicts a flowchart of an example process of further optimizing a cost-effective reliable utilities distribution network in accordance with an illustrative embodiment.

### DETAILED DESCRIPTION

The invention recognizes that a utility distribution network must be cost-effective to build and reliable in operation. For example, one simplistic approach to building a network can be to connect each consumer of the utility (consumer) to a supplier of the utility (supplier). However, such a simplistic approach does not takes into account the comparative cost of building the network to service the consumer from a first supplier versus a second supplier. For example, supplying from a first supplier that is nearer to the consumer is more cost effective as compared to supplying the consumer from a second supplier who is farther from the first supplier because the length of the wire or cable required is smaller with the first supplier.

Such a simplistic approach also does not have the reliability for continuity of service. For example, the utility cannot be provided to the consumer when the first supplier cannot supply the utility or the network between the first supplier and the consumer suffers a breakdown.

Another simplistic approach to building a network with some reliability is to arbitrarily service a consumer from two or more suppliers. Again, such an approach does not factor the comparative cost of building the network to service the consumer from different suppliers.

Several shortest path algorithms are known for selecting the shortest distance between two points, such as between consumers and suppliers. The invention recognizes that pairing a consumer with a supplier merely because the distance between the pair is the shortest is not a Sufficient solution to cost-effectiveness or reliability. For example, the nearest supplier to a consumer may be sporadic supplier, such as a supplier who converts wind energy to electricity.

Reliability can be achieved, for example, by doubling the wires in the network. However, such reliability is not cost-effective as such an approach wastes network resources, such as wirelength.

The invention recognizes that even when a network is designed for a given set of consumers and a given set of suppliers from the point of view of cost-effectiveness and reliability, such design process is not a result of an automated process and therefore not easily duplicated. Specific network design for specific suppliers and consumers may be cost-effective and reliable, but generally requires exhaustive search of the possible networking options through trial and error.

The illustrative embodiments used to describe the invention generally address and solve the above-described problems related to utilities distribution network design. The illustrative embodiments provide a method, system, and computer program product for designing a cost-effective and reliable utility distribution network.

The invention and various embodiments thereof are described herein primarily with respect to a simplified relationship between a limited number of consumers and suppliers of an example utility—electricity—only for the clarity of the disclosure. The concepts, methods, products, systems, operations, actions, configurations, or manipulations described herein with respect to designing a utility distribution network are similarly applicable to other types of utilities distribution networks and any number of consumers and suppliers without limitation.

The illustrative embodiments are described using specific algorithms and tools only as examples and are not limiting on the illustrative embodiments. The illustrative embodiments may be used in conjunction with other comparable or similarly purposed algorithms and tools within the scope of the invention. An illustrative embodiment may be implemented in hardware, software, or a combination thereof.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

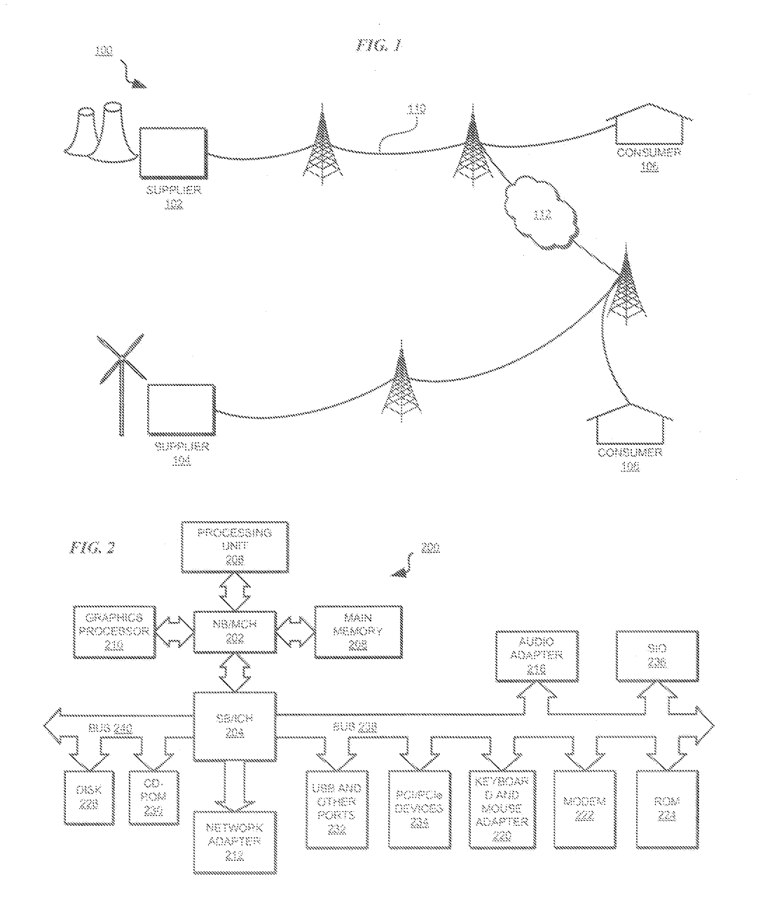

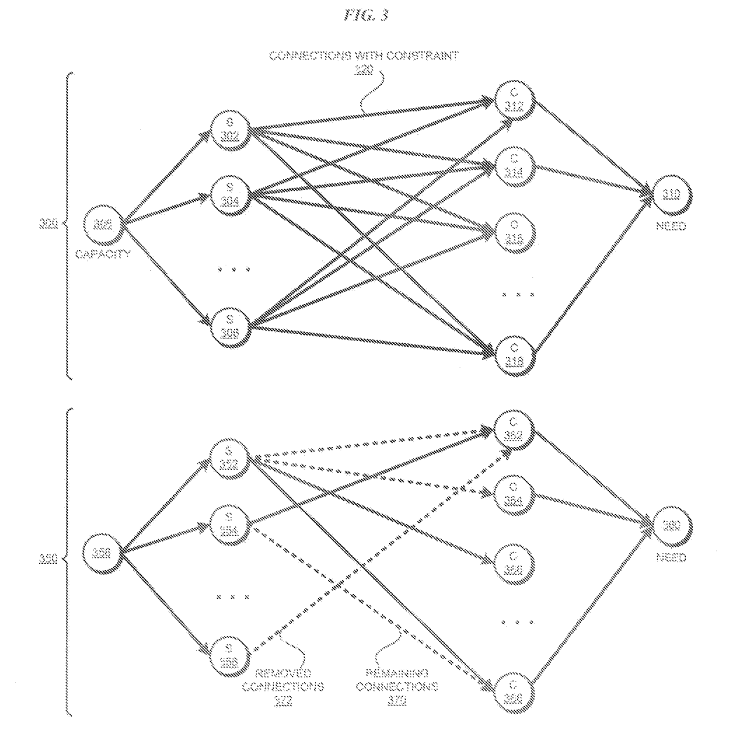

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of an example electricity distribution network in which illustrative embodiments may be implemented. Electricity distribution network 100 includes example suppliers 102 and 104. Supplier 102, as an example, may be a supplier who generates electricity using coal, oil, or nuclear power. Supplier 104, as an example, may be a less reliable supplier, such as one who generates electricity from wind or solar energy.

Network 100 further includes consumers 106 and 108. Wires 110 are part of network 100's infrastructure to deliver the example electrical utility from suppliers 102 and 104 to consumers 106 and 108. Wire/grid 112 may be a part of an example grid that brings electricity supply from several suppliers to several consumers. Switching circuits, transformers, and other components of a typical electricity distribution network are omitted from the depiction for the clarity of the illustration.

Wires 110, 112, and other omitted components of network are constructed at a cost. Assume that two designs of network 100 can deliver electricity from a common set of suppliers to a common set of consumers with the same degree of reliability. A design of network 100 that can distribute electricity from the set of suppliers to the set of consumers by using less than a threshold wirelength of wires 110 and 112 is more cost-effective than another design of network 100 that uses more than the threshold wirelength to do so.

With reference to FIG. 2, this figure depicts a block diagram of a data processing system in which illustrative embodiments may be implemented. Data processing system 200 is an example computer that can be used to implement a method according to an embodiment, a computer usable program product according to an embodiment, or a system according to an embodiment.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller, hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system. (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the abject-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in Figures 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

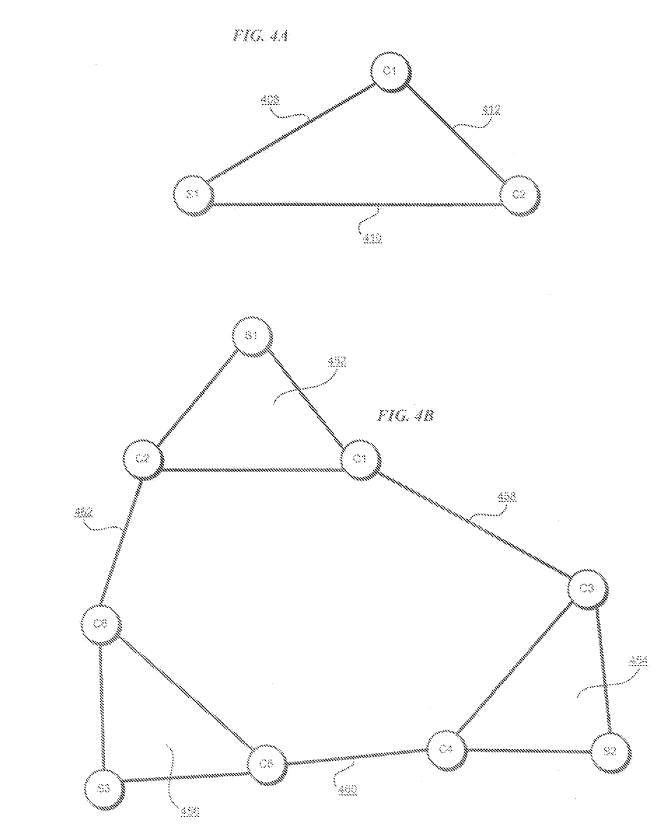

With reference to FIG. 3, this figure depicts a graph reduction process for designing a cost-effective network in accordance with an illustrative embodiment. In initial graph 300 of the design, supplier 302, 304, and 306 are any number of suppliers similar to suppliers 102 and 104 in FIG. 1. Suppliers 302-306 together have total supply capacity 308.

Total need 310 comprises needs of consumers 312, 314, 316, and 318. Consumers 312-318 may be any number of consumers similar to consumers 106 and 108 in FIG. 1.

As a first step in the design process of FIG. 3, each supplier 302-306 is connected with each consumer 312-318 using connections similar to connection 320 as shown. Note that connections 320 are not actual wire connections between suppliers 302-306 and consumers 312-318, but only conceptual connections for the design process.

Each of connections 320 is further configured with a maximum capacity constraint. For example, connection 320 between supplier 302 and consumer 318 may be constrained to carry only one hundred kilowatts of electrical power.

In graph 350 of the design, suppliers 352, 354, and 356 are the same as suppliers 302, 304, and 306; capacity 358 is the same as capacity 308; need 360 is the same as need 310, and consumers 362, 364, 366, and 368 are the same as consumers 312, 314, 316, and 318, respectively.

In graph 350 of the design process, some of connections 320 are removed and others are retained. Connections 370 are the remaining connections and connections 372 are the removed connections. Connections 372 are removed from graph 350 by using a minimum cost maximum flow algorithm. A minimum cost maximum flow algorithm is a known algorithm applied in other domains such as in integrated circuit design, seeks to satisfy the needs of a consumer node from a supplier node, without violating the constraint on the connection that satisfies that need.

The algorithm further seeks to maximize the flow over a connection up to the constraint of that connection, so that certain connections, such as connections 372, can be removed. The algorithm further seeks to create pairs of suppliers and consumers such that a supplier, such as supplier 352, is utilized up to a threshold capacity.

For example, assume that supplier 352 has a production capacity of one hundred megawatts, of which a threshold eighty percent supply capacity can be allocated to consumers by the algorithm. The algorithm pairs a subset of consumers 362-368 with supplier 352 such that supplier 352 supplies up to but not exceeding the threshold supply capacity.

Graph 350 is thus a network of lowest cost that clusters consumers around available suppliers. The minimum cost maximum flow algorithm removes connections 372 from graph 350. Wirelength of removed connections 372 is saved in graph 350 as compared to graph 300 by clustering subsets of consumers 362-368 with one of suppliers 352-356. Graph 350 saves the wirelength of connections 372 while maintaining the constraints of connections 370, the threshold supply capacities of suppliers 352-356, and satisfying the needs of consumers 362-368.

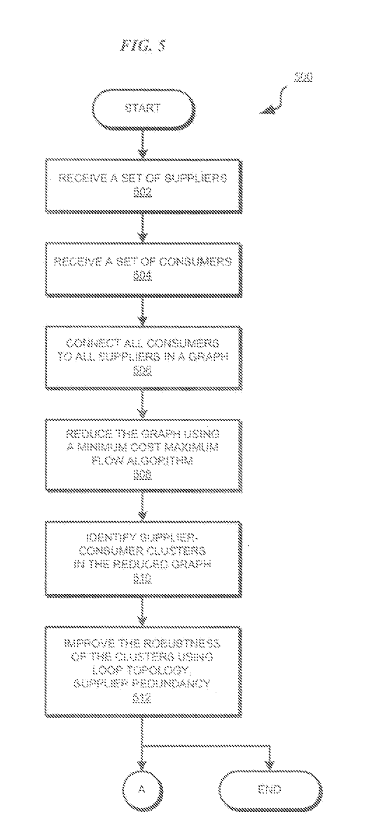

With reference to FIG. 4A, this figure depicts a simplified loop graph for reliability in accordance with an illustrative embodiment. Supplier 402 labeled “S1” is similar to supplier 352 in FIG. 3. Consumers 404 labeled “C1” and 406 labeled “C2” are a subset of consumers 362-368 in FIG. 3.

A loop structure of a network is the least cost network for reliably operating the network with one point failure. As depicted in FIG. 4A, supplier 402 can supply consumer 40.4 via connection 408 and consumer 406 via connection 410. However, failure of connection 408 leaves supply to consumer 406 disrupted and failure of connection 410 leaves supply to consumer 406 disrupted. The loop formed by connection 412 provides two paths to supply each of consumers 404 and 406.

Given any number of consumers in this manner, reliability of the network can be increased to sustain one point of failure without disruption of service by using a loop network according to an embodiment. Ordering of nodes, e.g., a supplier and a subset of consumers, within a loop to minimize cost, e.g., wirelength, is known as a Hamilton Cycle problem.

For an arbitrary sized collection of nodes, the Hamilton Cycle problem is an NP complete problem. However, an embodiment applies to a defined set Of finite nodes, i.e., a defined supplier and a defined subset of consumers as selected in the clustering described with respect to FIG. 3. Therefore, for a utilities distribution network optimization problem, an embodiment can find the lowest cost loop network solution in finite time. For example, an embodiment can simply enumerate all possible loops through the given supplier and subset of consumers, evaluate their costs, compare the costs, and select the least cost loop.

Having so selected a loop with the lowest cost, for example, the smallest wirelength in an electricity distribution network, the embodiment delivers a cost-effective network, because of wirelength.reduction achieved from removed connections 372 in FIG. 3; the cost-effective network also having improved reliability for a single failure, because of the loop computed according to FIG. 4A.

Note that FIG. 4A is depicted with only three nodes—one supplier and two consumers—only for the clarity of the illustration and not as a limitation on an embodiment. A node collection of any size, such as formed by using one supplier and any size of the subset of consumers, can similarly be used to compute a loop network to improve the reliability for single failure. Furthermore, when the collection of nodes exceeds a certain size, certain known heuristics can be employed to achieve a loop of a cost lower than a threshold cost.

Furthermore, the loop depicted in FIG. 4A and described herein improves reliability for a single failure in the loop only as an example. Using this disclosure, one of ordinary skill in the art can compute a loop network that can sustain two, three, or more failures in the loop, and continue utilities distribution without disruption. Such loops are contemplated within the scope of the illustrative embodiments.

With reference to FIG. 4B, this figure depicts a second form of improving reliability in a utilities distribution network in accordance with an illustrative embodiment. Each of loops 452, 454, and 456 are loops computed for one supplier and a subset of consumers as described with respect to FIG. 4A.

For example, loop 452 represents a cost-effective network between supplier S1 and consumers C1 and C2, which is reliable for uninterrupted supply of utility with one failure in loop 452. Similarly, loop 454 represents a cost-effective reliable network between supplier S2 and consumers C3 and C4. Loop 456 represents a cost-effective reliable network between supplier S3 and consumers C5 and C6.

In addition to improving the reliability of a network by incorporating the loop structure, an embodiment can further improve reliability by imparting supplier redundancy to a utility distribution network. As depicted in FIG. 4B, loops 452, 454, and 456 are further connected to each other via connections 458, 460, and 462.

For example, connection 458 serves to supply consumers C3 and C4 in loop 454 from supplier S1 in loop 452 if supplier S2 in loop 454 ceases supply. Connection 458 similarly serves to supply consumers C1 and C2 from supplier S2 when supplier S1 cannot provide the utility supply.

Connections 460 and 462 operate in a similar manner between loops 454 and 456, loops 456 and 452 respectively. Thus, according to an embodiment, the network depicted in FIG. 4B is cost-effective (because of the wirelength reduction of FIG. 3), reliable for single failure (because of loop structure of FIG. 4A), and further reliable for supplier redundancy (because of the interconnections between loops, as in FIG. 4B).

Note that an existing network can be reconfigured using a combination of the embodiments in a similar manner. For example, an existing network can be reconfigured to remove certain connections in the manner of graph 350 in FIG. 3, thereby reducing the maintenance cost of the network. As another example, an existing network can be reconfigured to include loops in the manner of an embodiment described with respect to FIG. 4A to improve reliability. As another example, an existing network can be reconfigured in the manner of an embodiment described with respect to FIG. 4B to improve reliability by providing supplier redundancy.

As another example, an existing network can be expanded in accordance with one or more embodiments described with respect to FIG. 3, 4A, and 4B in a similar manner. Thus, not only can an embodiment help design a cost-effective and reliable utilities distribution network from the ground-up, such as when new supply areas are planned, but also improve or expand an existing network, such as when existing supply areas expand, or new buildings or sub-divisions are contemplated.

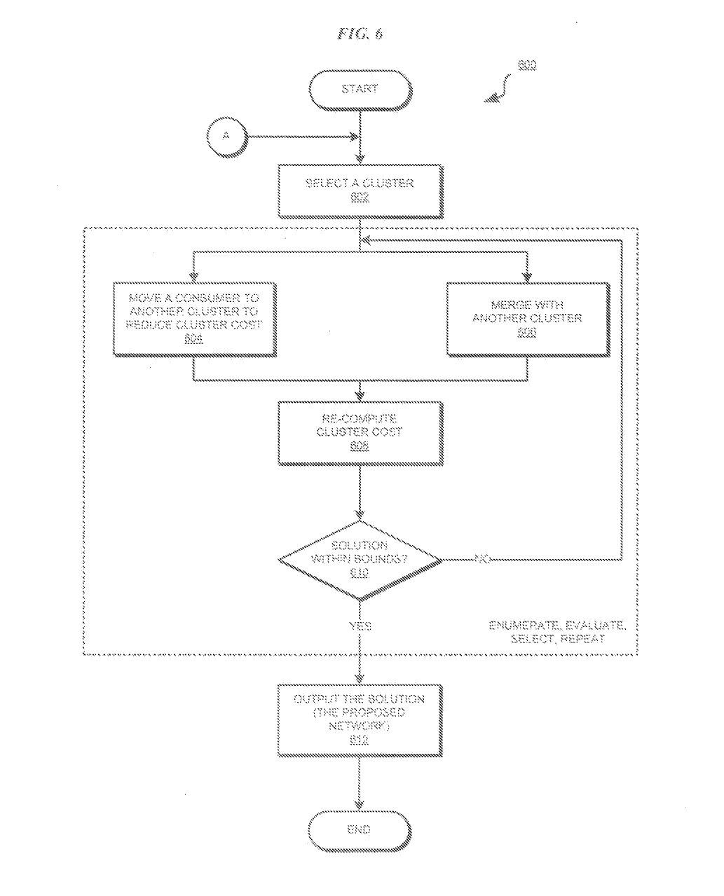

With reference to FIG. 5, this figure depicts a flowchart of a process of designing a cost-effective and reliable utilities distribution network in accordance with an illustrative embodiment. Process 500 can be implemented in a software application, including computer usable code that can execute on a computer such as data processing system 200 in FIG. 2.

Process 500 begins by receiving a set of suppliers (step 502). Process 500 receives a set of consumers (step 504).

Process 500 connects each consumer to each supplier, such as in graph 300 in FIG. 3 (step 506). Process 500 reduces the number of connections using a minimum cost maximum flow algorithm, such as in graph 350 in FIG. 3 (step 508).

Process 500 identifies one or more supplier-consumer clusters in the reduced graph of step 508, a cluster forming a network (step 510). Process 500 improves the robustness (reliability) of the one or more identified clusters by computing a loop topology for the clusters (step 512). Optionally, process 500 may further improve the robustness of the clusters in step 512 by computing connections for supplier redundancy as described with respect to FIG. 4B. Process 500 may end thereafter, or proceed to join process 600 in FIG. 6 via exit point marked “A”.

With reference to FIG. 6, this figure depicts a flowchart of an example process of further optimizing a cost-effective reliable utilities distribution network in accordance with an illustrative embodiment. Process 600 can be implemented in a software application similar to the implementation of process 500 in FIG. 5.

Once a cost-effective reliable network has been computed, with or without supplier redundancy, as described herein, the network can be further optimized for further cost reduction, supply efficiency, maintenance reduction, and other tangible and non-tangible advantages. For example, given a set of suppliers and a set of consumers, a network having a number of connections defined by Hamilton Cycle lower bound can be achieved as described above. If the reliability improvement requires dual supply paths to each consumer, an upper bound for the number of connections can be set at twice the Steiner tree length for the graph of the network.

Furthermore, during the cluster forming phase, as in graph 350 in FIG. 3, one cost-reduction consideration was the supplier-to-consumer distance. For example, in addition to that consideration, an optimization process according to an embodiment further considers consumer-to-consumer distances to compute a cluster, such as by bounding the consumer-to-consumer distances in a cluster to below a threshold, in preparation for the loop computation of FIG. 4A.

As another example, for existing networks, an embodiment considers existing supplier-consumer connection costs in optimizing a network computation for expansion. As another example, an embodiment can alter a clustering from a previous iteration of graph reduction, such as by placing certain consumers with certain suppliers or certain other consumers, and recompute a reduced graph. Such manipulations of clusters can result in merging of two or more clusters into a larger cluster, which can lead to increased wirelength savings under certain circumstances.

As another example, an embodiment compares the cost of loop based improvement in reliability and redundant suppliers-based improvement in reliability, choosing one or the other but not both for better cost savings. Process 600 in FIG. 6 is an example process to perform some of these optimization steps according to an embodiment.

Process 600 begins by selecting a cluster (step 602). Another process, such as process 500 in FIG. 5, can enter process 600 at entry point marked “A” and proceed to step 602.

Process 600 moves a consumer from one cluster to another cluster to reduce a cluster cost (step 604). For example, when a consumer is removed from one network, the wirelength for supplying that consumer in that cluster can be removed, thus reducing the cluster cost. Such a move is useful when, for example, a supplier in the cluster is being utilized above a threshold supply capacity.

Alternatively, or in conjunction with step 604, process 600 merges one cluster with another (step 606). Merging two or more clusters together can reduce the total wirelength in the combined graph, thereby reducing the cost of the combined cluster.

Process 600 re-computes the cost of the cluster resulting from step 604, 606, or both (step 608). Process 600 determines whether the solution—the graph or the resulting cluster or network—meets certain bounds (step 610). For example, as described above for single failure reliability, the upper bound of the solution may be set to twice the Steiner tree length of the Steiner tree possible with the supplier and consumer nodes in the cluster.

If the solution cost is not within bounds (“NO” path of step 610), such as when the solution cost exceeds the threshold defined by 2*Steiner tree length in the above example, process 600 returns to perform another iteration of step 604, 606, or both. If the solution cost is within bounds (“Yes” path of step 610), process 600 proceeds to step 612. Of course, any suitable condition can be specified in step 610 within the scope of the illustrative embodiments.

Process 600 performs steps 604, 606, 608, and 610 in an iterative manner until certain conditions are met as described here. In such iterations, process 600 enumerates the possible solutions resulting from performing step 604, 606, or both; evaluates the enumerated solutions in step 608; selects a desirable solution based on the computation of step 608; and repeats steps 604, 606, and 608 if the specified condition in step 610 is not met.

Process 600 outputs the solution—the proposed cost-effective and reliable network (step 612). Process 600 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for creating or modifying a cost-effective and reliable utilities distribution network. Using an embodiment of the invention a new or existing network can be designed to reduce cost, such as wirelength or pipe-length, in the network. While certain embodiments are described with respect to distances between nodes as a cost function, such cost functions are only used as examples and not as a limitation on the invention. Other cost functions, such as a type of wire or pipe, cost of load-balancing on a certain supplier or connection, upper or lower bound on the cluster cost, can also be used in conjunction with an embodiment in a similar manner within the scope of the invention.

An embodiment can be used to design a network to reliably accommodate sporadic suppliers, and future growth requirements. An embodiment produces a network that meets a cost criterion at the time of design and yet allow a growth path in the network's design to maintain the reliability or robustness of the network upon growth.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “device,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means fat implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for designing a cost-effective and reliable distribution network for a utility (network), the method comprising:
reducing a graph connecting a set of consumers of the utility with a set of suppliers of the utility to form a plurality of clusters;
improving a first network between a supplier and a subset of consumers in a first cluster in the plurality of clusters, the improving adding a first connection in the first network to provide continuity of supply of the utility to the subset of consumers after a predetermined number of failures in the first network; and
generating a design for a second network connecting the set of suppliers to the set of consumers, the second network including the first network after the improving, wherein the second network has a cost that is within a lower threshold and an upper threshold.

2. The computer implemented method of claim 1, wherein adding the connection in the network forms a loop in the network, the loop providing dual supply paths to each consumer in the subset of consumers in the cluster.

3. The computer implemented method of claim 1, further comprising:
further improving the first network by adding a second connection from the first network to a third network, the third network being formed between a second supplier and a second subset of consumers in a second cluster in the plurality of clusters, the second connection providing supplier redundancy to the first and third networks.

4. The computer implemented method of claim 1, further comprising:
moving a consumer from the first cluster to a second cluster in the plurality of clusters, the moving reducing a cost of the first cluster.

5. The computer implemented method of claim 1, further comprising:
merging the first cluster with a second cluster, the merging reducing a total cost of the first and second clusters.

6. The computer implemented method of claim 1, further comprising:
merging the first cluster with a second cluster, the Merging providing supplier redundancy to the first and second clusters.

7. The computer implemented method of claim 1, wherein the second network has a reliability to continue supply of the utility after the predetermined number of failures.

8. The computer implemented method of claim 1, wherein the cost of the second network is a total length of all connections in the second network.

9. The computer implemented method of claim 1, wherein the lower threshold for the cost of the second network is a total length of a Hamilton Cycle formed for connecting each consumer in the set of consumers with a supplier in the set of suppliers, and wherein the upper threshold for the cost of the second network is a multiple of total length of a Steiner tree formed for connecting each consumer in the set of consumers with a supplier in the set of suppliers.

10. The computer implemented method of claim 9, wherein the multiple has a value 2, the multiple value of 2 providing reliability in the second network against a single failure.

11. The computer implemented method of claim 1, wherein the failure in the network is a failure of a connection in the network.

12. The computer implemented method of claim 1, wherein a connection in the graph has a capacity constraint, and a supplier in the set of suppliers has a threshold supply capacity, and wherein the reducing does not violate the capacity constraint and the threshold supply capacity.

13. The computer implemented method of claim 1, wherein the reducing uses a minimum cost maximum flow algorithm for reducing the graph.

14. The computer implemented method of claim 1, wherein the utility is electricity, and the distribution network for the utility is an electricity distribution network.

15. A computer usable program product comprising a computer usable storage medium including computer usable code for designing a cost-effective and reliable distribution network for a utility (network), the computer usable code comprising:
computer usable code for reducing a graph connecting a set of consumers of the utility with a set of suppliers of the utility to form a plurality of clusters;
computer usable code for improving a first network between a supplier and a subset of consumers in a first cluster in the plurality of clusters, the improving adding a first connection in the first network to provide continuity of supply of the utility to the subset of consumers after a predetermined number of failures in the first network; and
computer usable code for generating a design for a second network connecting the set of suppliers to the set of consumers, the second network including the first network after the improving, wherein the second network has a cost that is within a lower threshold and an upper threshold.

16. The computer usable program product of claim 15, wherein adding the connection in the network forms a loop in the network, the loop providing dual supply paths to each consumer in the subset of consumers in the cluster.

17. The computer usable program product of claim 15, further comprising:
computer usable code for further improving the first network by adding a second connection from the first network to a third network, the third network being formed between a second supplier and a second subset of consumers in a second cluster in the plurality of clusters, the second connection providing supplier redundancy to the first and third networks.

18. The computer usable program product of claim 15, wherein the computer usable code is stored in a computer readable storage medium in a data processing system, and wherein the computer usable code is transferred over a network from a remote data processing system.

19. The computer usable program product of claim 15, wherein the computer usable code is stored in a computer readable storage medium in a server data processing system, and wherein the computer usable code is downloaded over a network to a remote data processing system for use in a computer readable storage medium associated with the remote data processing system.

20. A data processing system for designing a cost-effective and reliable distribution network for a utility (network), the data processing system comprising:
a storage device including a storage medium, wherein the storage device stores computer usable program code; and
a processor, wherein the processor executes the computer usable program code, and wherein the computer usable program code comprises:
computer usable code for reducing a graph connecting a set of consumers of the utility with a set of suppliers of the utility to form a plurality of clusters;
computer usable code for improving a first network between a supplier and a subset of consumers in a first cluster in the plurality of clusters, the improving adding a first connection in the first network to provide continuity of supply of the utility to the subset of consumers after a predetermined number of failures in the first network; and
computer usable code for generating a design for a second-network connecting the set of suppliers to the set of consumers, the second network including the first network after the improving, wherein the second network has a cost that is within a lower threshold and an upper threshold.
